(19) United States
(12) Patent Application Publication
(10) Pub. No.: US 2014/0138344 A1
(43) Pub. Date: May 22, 2014

(54) MAGNETIC WATER BOTTLE

(71) Applicant: Lars Ola Bengtsson, Forest Hills, NY (US)

(72) Inventor: Lars Ola Bengtsson, Forest Hills, NY (US)

(21) Appl. No.: 14/232,042

(22) PCT Filed: Jul. 13, 2012
(86) PCT No.: PCT/US2012/046661

§ 371 Date: Jan. 10, 2014

Related U.S. Application Data
(60) Provisional application No. 61/572,241, filed on Jul. 14, 2011.

(51) Int. Cl. C02F 1/48; B65D 23/12

(52) U.S. Cl. CPC C02F 1/482; B65D 23/12
USPC 215/386

(57) ABSTRACT

A magnetic water bottle is disclosed that is amenable to mass production by automated manufacturing methods. In accordance with the present invention, the magnetic water bottle is re-useable, recyclable and disposable and may be made from plastic or glass. In one embodiment of the invention, one or more elongated magnets are received in axially orientated recesses. The magnets are held in place by a suitable adhesive or alternatively by a plastic strip ultrasonically welded over the magnet to hold it in place or alternatively are held in place by a friction fit. In an alternate embodiment of the invention, magnetic straps formed from bendable magnets are received in radially orientated recesses in bottle. The magnetic straps are held in place in a manner as discussed above.

### CROSS REFERENCE TO RELATED APPLICATIONS

This application claims priority to and the benefit of U.S. Patent Provisional Patent Application No. 61/572,241, filed on Jul. 14, 2011, hereby incorporated by reference.

### BACKGROUND OF THE INVENTION

1. Field of the Invention

The present invention relates to a water bottle for carrying fluids for human consumption and more particularly to a recyclable, reusable and/or disposable plastic or glass bottle or container (hereinafter “bottle”) that incorporates one or more magnets for imparting a magnetic field to the liquid inside container in order to provide a therapeutic benefit to the consumer of the fluid.

2. Description of the Prior Art.

There has been considerable research in the field of magnetics over the years and the therapeutic effects of water and other fluids that have been exposed to a magnetic field. It is also known that when water is exposed to a magnetic field, it becomes softer as is experienced to have a smoother and “wetter” feel than, for example, municipal water. Various devices have been developed to take advantage of the therapeutic effect of water or other liquid that has been exposed to a magnetic field. Examples of the devices are discussed below.

Chinese Utility Model Patent Application CN 2178068 discloses a magnetic water bottle which includes a pair of spaced apart elongated rectangular plates, attached in axially orientated recesses formed in a lower exterior surface of the bottle. Each plate carries a column of magnetic beads. An iron sheet is wrapped around the lower exterior surface of the bottle. The iron sheet performs several functions. First, it appears to hold the rectangular plates with the magnetic beads in place relative to the bottle. Second, the iron sheet is a magnetic conductor and thus acts as a pole piece to distribute the magnetic field around the bottle. Third, the iron sheet may also be used as a label for the bottle and/or product within the bottle.

There are several problems with the magnetic bottle disclosed in the Chinese Utility Model Application mentioned above. First, the magnetic beads produce very little gauss and therefore may not be able to expose the water to a sufficient magnetic field to produce the desired therapeutic effect. Second, magnetic water bottle disclosed in the Chinese Utility Model Application mentioned above is relatively complicated and expensive from a manufacturing standpoint. Third, the magnetic bottle would make storage complicated and reuse virtually impossible due to oxidation and rust.

Japanese Patent No. JP10236452 discloses a magnetic water bottle. Bendable magnets are formed in a semicircular shape and received in circular recesses formed in the bottle neck and an upper exterior portion of the bottle. Two magnets, each formed in a semicircular shape, are received in each of the circular recesses. Adjustable clamps are attached to the magnets and are used to tighten the magnets in the circular recesses in order to hold them in place.

There are several problems with the magnetic water bottle disclosed in the Japanese patent. First, the magnetic water bottle is relatively complicated from a manufacturing standpoint. Second, it appears that the clamps, identified as a “bolt-nut tightening device” would need to be manually tightened. As such, the magnetic water bottle disclosed in the Japanese patent would not be subject to mass production by automated manufacturing methods.

Other bottles are known which include removable and reuse-able straps that are manually applied and removed by the consumer. Examples of these devices are disclosed in Japanese Laid Open Application No. JP 2005/5342481 A2 and U.S. Pat. No. 7,344,646. However, these devices would likely not be popular in today's market for bottled water. More specifically, in today's market, bottled water is available for purchase in most retail establishments. In order for consumers to reap the benefits of magnetized water using the re-useable straps discussed above, the consumers would need to carry the re-usable straps with them. Not only would this be cumbersome, but it would likely set off security alarms in retail stores that use magnetic detectors at their entrances and exits to detect shoplifters.

Thus, there is a need for a magnetic water bottle that is suitable for mass production by automated manufacturing methods.

### SUMMARY OF THE INVENTION

Briefly, the present invention relates to a magnetic water bottle that is amenable to mass production by automated manufacturing methods and is relatively inexpensive to manufacture. In accordance with the present invention, the magnetic water bottle is re-useable, recyclable and disposable and may be made from plastic or glass. In one embodiment of the invention, one or more elongated magnets are received in axially orientated recesses The magnets are held in place by a suitable adhesive or alternatively by a plastic strip ultrasonically welded over the magnet to hold it in place or held in place by a friction fit. In an alternate embodiment of the invention, magnetic straps formed from bendable magnets are received in radially orientated recesses in bottle. The magnetic straps are held in place in a manner as discussed above. The magnetic water bottles in accordance with the present invention are amenable to mass production by automated manufacturing processes and are thus suitable for use as disposable magnetic water bottles.

### DESCRIPTION OF THE DRAWING

These and other advantages of the present invention will be readily understood with reference to the following specification and attached drawing wherein:

FIG. 1 is an elevational view of one embodiment of the invention illustrating a water bottle with a plurality of radially oriented straps secured to the perimeter of the bottle.

FIG. 2 is similar to FIG. 1, but shown with the water bottle tipped to illustrate an alternate embodiment that includes a magnet disposed on the bottom surface of the water bottle.

FIG. 3 is third alternate embodiment of the invention, shown with a magnet disposed inside the water bottle.

FIG. 4 illustrates a fourth alternate embodiment of a magnetic water bottle illustrating a magnet suspended inside the water bottle by way of a pendulum.

FIG. 5 is a perspective view of a fifth water bottle shown with a magnet disposed along the outside of the bottle in an axial direction.

FIG. 6 is a top view of the water bottle illustrated in FIG. 5.

FIG. 7 is a partial sectional view of the water bottle illustrated in FIG. 5 shown with a relatively deep axially oriented recess so that the magnet is generally flush with the periphery of the water bottle when the magnet is installed.

FIG. 8 is similar to FIG. 7 but shown with a relatively shallower recess resulting in the magnet extending outwardly from the surface of the water bottle when the magnet is installed in the recess.

FIG. 9 is an elevational view of a sixth embodiment of a magnetic water bottle illustrating an axially oriented magnet held in place by a cover attached to the periphery of the water bottle.

FIG. 10 is a sectional view of the water bottle illustrated in FIG. 9.

### DETAILED DESCRIPTION

The present invention relates to a magnetic water bottle that is amenable to mass production by automated manufacturing methods. In accordance with the present invention, the magnetic water bottle is re-useable, recyclable and disposable and may be made from plastic or glass. In one embodiment of the invention, one or more elongated magnets are received in axially orientated recesses or alternatively attached directly to an exterior surface of the water bottle. The magnets may be held in place by a suitable adhesive or alternatively by a plastic strip ultrasonically welded over the magnet to hold it in place or alternatively are held in place by a friction fit. In an alternate embodiment of the invention, magnetic straps formed from bendable magnets are received in radially orientated recesses in the water bottle or alternatively attached to an exterior surface of the water bottle. The magnetic straps are held in place in a manner as discussed above.

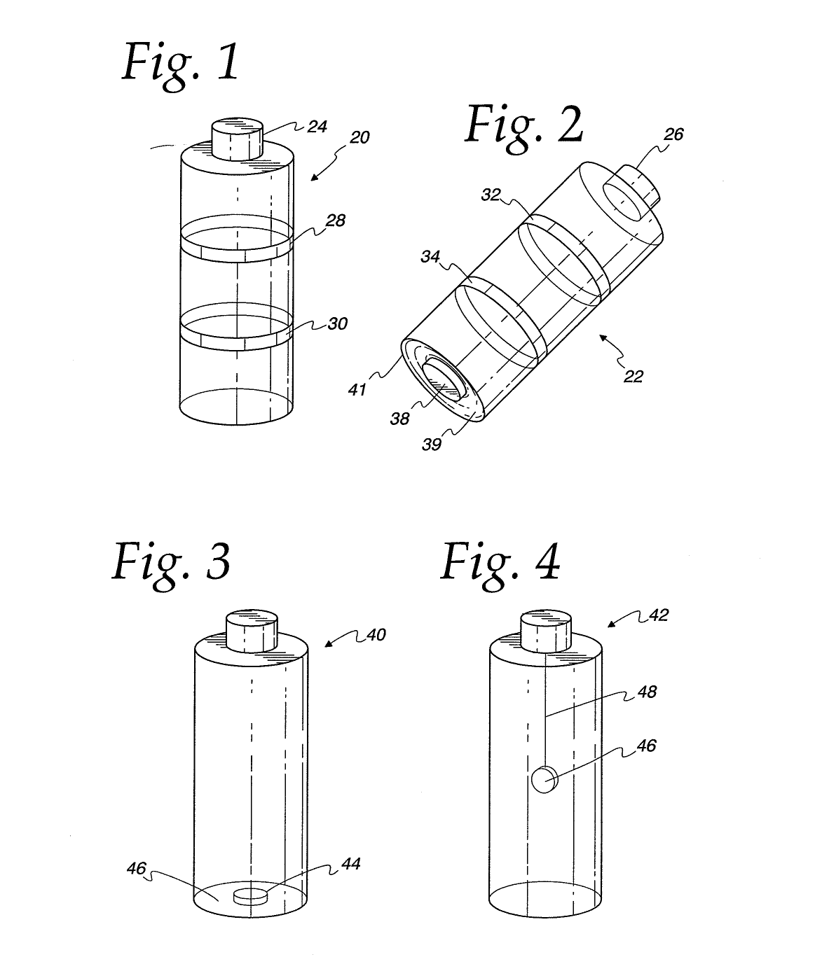

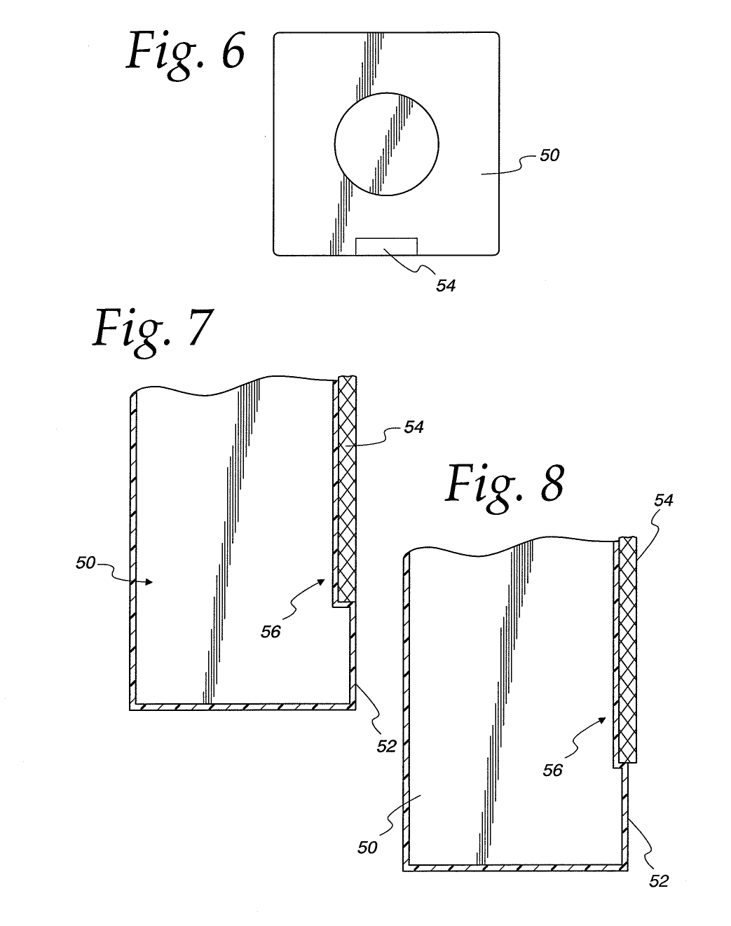

In accordance with an important aspect of the present invention, the various embodiments of the invention illustrated herein are configured so that they can be mass produced by conventional automated manufacturing methods. For example, the water bottles disclosed in FIGS. 1-9 can be fabricated from various plastic materials, such as polyethylene teraphthalate (PET), which is commonly used for beverage bottles. PET is high gloss and crack resistant which makes it desirable for a water bottle. Other plastics with the same or similar characteristics are also contemplated.

Various conventional manufacturing methods are known for forming water bottles. For example, one method is known as Injection Stretch Blow Molding (ISBM) which involves a two-step process. In the first step, liquefied PET or other plastic or other material is injected into a cavity and formed into a generally test tube shape or preform. The preform is then cooled down. Once the preform is cooled down, it is reheated and softened. Next, the preform is rapidly heated and placed in a blow mold. Hot air is used to inflate the preform and stretch it to its finished shape.

The plastic water bottle caps may be made from PET or other plastics other than PET, such as high ethylene polyethylene (HDPE) or other plastic relatively less dense than water. Use of a different material for the cap facilitates removal of the cap during recycling. The plastic water bottle caps are known to be made by injection molding.

Turning to FIGS. 1 and 2, first and second embodiments of the invention are illustrated and generally identified with the reference numerals 20 and 22, respectively. As shown, the bottles 20 and 30 are shown as being configured in a cylindrical shape with an extending neck (not shown) having a diameter relatively smaller than the diameter of the bottle 20, 30. Each of the bottles 20, 30 are closed by a plastic cap 24,26, respectively. However, the principles of the present invention are applicable to virtually any shape bottle which can accommodate the attachment of a magnet.

In accordance with an aspect of the invention, one or more magnets 28, 30 and 32, 24, respectively, may be disposed as a band around the exterior surface of the bottles 20, 30. The magnets 28, 30 and 32, 24 may be disposed on an exterior surface of the water bottles 20, 30 around the perimeter without a recess. Alternatively, the bottles 20, 30 may be formed with radially oriented recesses around the perimeter of the bottles 20,30 that are configured to receive the magnets 28, 30 and 32, 34. The magnets 28, 30 and 32, 34 may be secured to the exterior surface or within the recesses with an adhesive, such as, an epoxy or other adhesive. The magnets 28, 30 and 32, 34 may be cut to shape by an automated method and installed either manually or by an automated process.

These magnets 28, 30 and 32, 34 are bendable magnets and cut to length to fit around the perimeter of the bottle 20, 30 as shown. Such bendable magnets are commonly known as “refrigerator or bendable magnets and are known to be formed from high-coercivity ferromagnetic compounds, such as, ferric oxide, and mixed with a plastic binder and extruded as a sheet. The sheet is passed on a conveyor belt over a line of powerful cylindrical permanent magnets. Depending on the orientation of the permanent magnets, the flexible magnets can be polarized as either unipolar as: NNNNNN or SSSSSS or bipolar as NSNSNS. Various shapes of the magnet are contemplated to be within the broad scope of the invention.

Magnets with various magnetic field strengths are also considered to be within the broad scope of the invention. For example, one or more magnet bands per bottle proving a total magnetic field strength of 500 gauss or more may be used. Other magnets having more or less field strength can also be used. Additional magnetic field strength can be provided, for example, by adding a commonly available disc magnet 38. Such disc magnets are formed from neodymium in the shape of round flat discs. The disc magnets may be nickel plated and axially magnetized having field strengths up to 14 kilo-Gauss, for example.

The bottle 22 is formed with a recessed bottom surface 39. The depth of the recess is sized to be slightly greater than the thickness of the disk magnet 38. In this way a rim 41 is formed on the bottom of the bottle 22. The bottle 22 is able to rest on the rim 41 on a flat surface with no interference from the magnet 38.

The third and fourth embodiments are illustrated in FIGS. 3 and 4 and generally identified with the reference numerals 40 and 42. These bottles 40 and 42 are similar to the bottles 20 and 22. The only differences relate to the implementation of the magnet. In the embodiment illustrated in FIG. 3, a disc magnet 44 is disposed inside the bottle 40. The disc magnet 44 is sized to have a relatively smaller diameter than the diameter of the bottle neck. The disc magnet is inserted through the bottle neck and may either free float in the bottle or attached to the floor 46 of the bottle 40 by way of a US Food and Drug Administration (FDA) compliant adhesive. In FIG. 4, a disc magnet 46 is suspended from the bottle neck and attached to a pendulum 48, for example, by way of an FDA compliant adhesive.

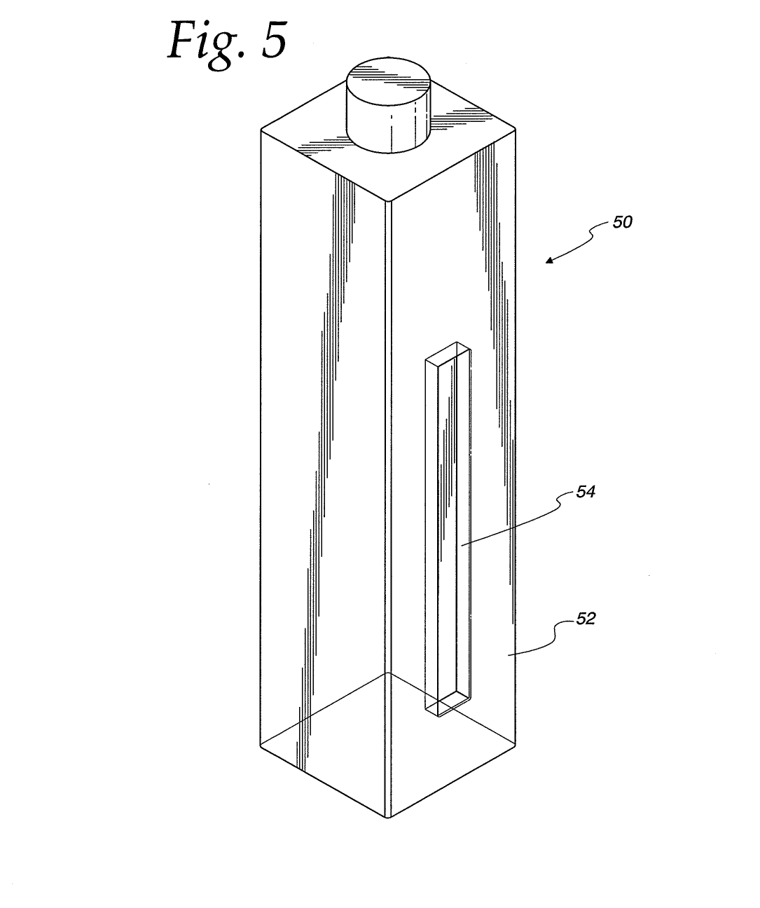

FIGS. 5-7 illustrate another alternative embodiment of the invention, generally identified with the reference numeral 50. In this embodiment, the bottle 50 is formed in a generally rectangular shape. The rectangular shape provides a generally flat surface 52 for accommodating an elongated rectangular magnet 54. The magnet 54 may be received in a recess 56 or 58, formed in the surface 52 of the bottle 50. In particular, as shown in FIG. 7, the recess 56 is sized so that the magnet 54 is flush with the surface 52 of the bottle 50. Alternatively, as shown in FIG. 8, the recess 58 is formed so that the magnet protrudes outwardly from the surface 52 of the bottle 50. The magnet 54 may be secured in the recess 56, 58 with an adhesive, such as epoxy, as discussed above. Alternatively, the magnet 54 can be secured directly to an exterior surface of the bottle 50 without a recess.

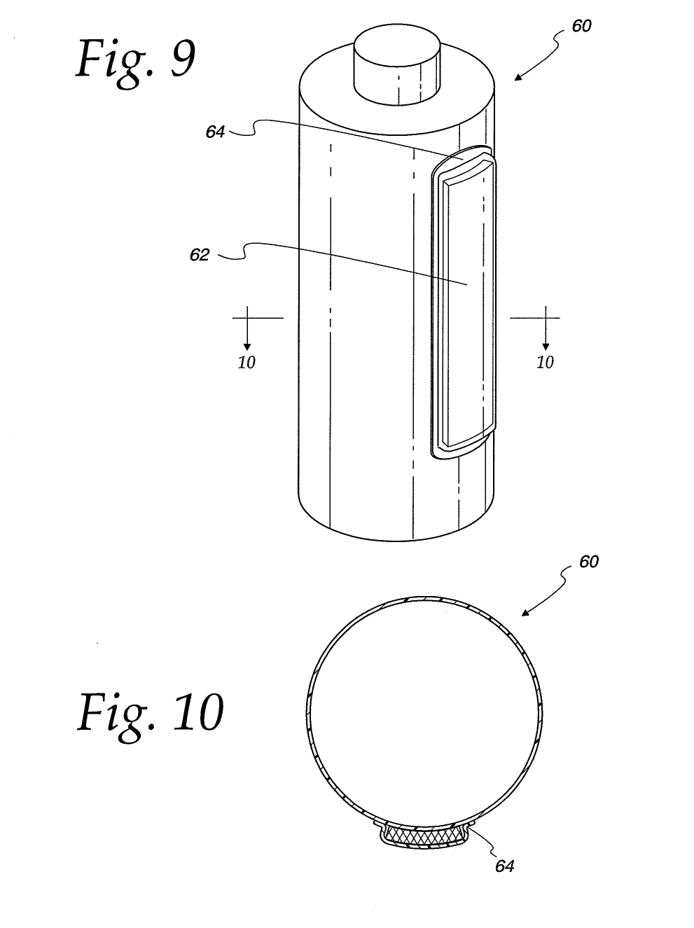

FIGS. 9 and 10 illustrate another alternate embodiment of the invention incorporated into a bottle 60. In this embodiment, a bendable magnet 62, as discussed above, is bent to conform to the curvature of the bottle 60. The magnet .62 may then attached to an exterior surface of the bottle 60 without a recess or alternatively within a recess formed in the bottle 60. In both embodiments, the magnet 62 may be initially held in place by an adhesive. Once the magnet 62 is in place, a cover 64, formed, for example, from the same material as the bottle 60 and formed to encapsulate thee sides of the magnet 62, may be inserted over the magnet 62. The cover 64 may be secured to the bottle 60 by way of ultrasonic welding or by way of an adhesive. A cover may also be used to hold the magnet 54 in place in an embodiment as illustrated in FIGS. 5-7.

As mentioned above magnetized water is known to have therapeutic effects. In one demonstration, a container of water in a glass with a bipolar magnetic straps was exposed to a total field strength of 500 Gauss for 2-5 days. Subjects ingested 8-12 ounces of the water exposed to the magnetic field. As shown below, the subject's blood cells were sampled before the water was ingested and 10-30 minutes afterward. As illustrated below, a clear improvement of the blood structure was noted.

Obviously, many modifications and variations of the present invention are possible in light of the above teachings. Thus, it is to be understood that, within the scope of the appended claims, the invention may be practiced otherwise than as specifically described above. For example, the principles of the invention are applicable to virtually all shapes of bottles and can be used for water, as discussed above, and virtually any other liquid.

What is claimed and desired to be secured by a Letters Patent of the United States is:

1. A magnetic water bottle comprising:
a bottle having an exterior surface;
one or more bendable magnets secured to said exterior surface; and
an adhesive for securing said magnet to said exterior surface.

2. The magnetic water bottle as recited in claim 1, further including a disc magnet attached to said water bottle.

3. The magnetic water bottle as recited in claim 2 wherein a bottom surface of the bottle is formed with a recess for receiving the disc magnet.

4. The magnetic water bottle as recited in claim 1, wherein said bottle is formed from a disposable material.

5. The magnetic water bottle as recited in claim 1, wherein said one or more bendable magnets are bendable.

6. The magnetic water bottle as recited in claim 5, wherein said one or more magnets are secured around the perimeter of the bottle in a radial orientation.

7. The magnetic water bottle as recited in claim 5, wherein said one or more magnets are secured to an exterior surface of the bottle in an axial orientation.

8. A magnetic water bottle comprising:
a bottle having an exterior surface;
a recess formed in the surface of the bottle for receiving a magnet; and
one or more magnets secured in said recess.

9. The magnetic water bottle as recited in claim 8, further including an adhesive for securing said one or more magnets in said recess.

10. The magnetic water bottle as recited in claim 8, further including a cover attached to said bottle for securing said one or more magnets in said recess.

11. The magnetic water bottle as recited in claim 8, wherein said one or more magnets are secured around the perimeter of the bottle in a radial orientation.

12. The magnetic water bottle as recited in claim 8, wherein said one or more magnets are secured to an exterior surface of the bottle in an axial orientation.

13. A magnetic water bottle comprising:
a bottle having an exterior surface;
one or more magnets secured to said exterior surface; and
a cover for securing said one or more magnets to said exterior surface.

14. The magnetic water bottle as recited in claim 13, wherein said one or more magnets are secured around the perimeter of the bottle in a radial orientation.

15. The magnetic water bottle as recited in claim 13, wherein said one or more magnets are secured to an exterior surface of the bottle in an axial orientation.
